(19) United States
(12) Patent Application Publication
(10) Pub. No.: US 2022/0145607 A1
(43) Pub. Date: May 12, 2022

(54) DRAINAGE CHANNEL AND GRATE ASSEMBLY

(71) Applicant: ReIn Pty Ltd, Ingleburn NSW (AU)

(72) Inventors: David Michael McDonald, Ingleburn NSW (AU); Luke Nigel Nattrass, Ingleburn NSW (AU)

(21) Appl. No.: 17/453,617

(22) Filed: Nov. 4, 2021

(30) Foreign Application Priority Data
Nov. 6, 2020 (AU) 2020103279

(51) Int. Cl. E03F 5/14

(52) U.S. Cl. CPC E03F 5/14; E01C 11/227

(57) ABSTRACT

The invention is broadly directed to a drainage channel and grate assembly 10 comprising a plurality of drainage channels 12a and 12b and a plurality of drainage grates 14a to 14c. The drainage channels 12a/b join one another at a channel junction 16ab in an end to end relationship. The drainage grates 14a to 14c are also arranged in an end to end relationship and are connected to either one or both of the drainage channels 12a/b. One of the plurality of drainage grates 14b bridges the channel junction 16ab to support the drainage channel and grate assembly 10 at set junction 16ab.

### RELATED APPLICATIONS

This application claims priority to and benefit of Australian Patent Application No. 2020103279 filed with the Australian Patent Office on Nov. 6, 2020. All of the aforementioned applications are incorporated herein in their respective entireties by this reference.

### TECHNICAL FIELD

The present invention is broadly directed to a drainage channel and grate assembly.

### SUMMARY OF INVENTION

According to the present invention there is provided a drainage channel and grate assembly comprising:

a plurality of drainage channels adjoining one another at one or more channel junctions in an end to end relationship;

a plurality of drainage grates connected to the drainage channels, at least one of said grates bridging respective of the channel junctions to support the drainage channel and grate assembly at said channel junction.

Preferably there are two (2) of the plurality of drainage channels each being of substantially the same length C. More preferably there is one (1) of the plurality of drainage grates bridging the channel junction, said bridging grate being of length G1 being equal to 2C/3. Furthermore, said assembly comprises drainage grates at opposing ends of the adjoining channels, each of said end grates being of substantially the same length G2 being equal to G1.

In another embodiment, there are three (3) of the plurality of drainage channels each being of substantially the same length C. In this other embodiment, there are two (2) of the plurality of drainage grates bridging the channel junctions each of said bridging grates being of substantially the same length G1 being equal to C. Furthermore, said assembly comprises drainage grates at opposing ends of the adjoining channels, each of said end grates being of substantially the same length G2 being equal to C/2. In a variation on this other embodiment there are two (2) of the plurality of drainage grates bridging the channel junctions each of said bridging grates being of substantially the same length G being equal to 3C/2.

In a variation on these embodiments, there are nC of the plurality of drainage channels each being of substantially the same length C, where nC is equal to or great than four (4). In this alternative embodiment there are nG of the plurality of drainage grates bridging the channel junctions each of said bridging grates being substantially the same length G1 being equal to C, where nG is equal to nC-1. Furthermore, the drainage channel and grate assembly comprises two (2) of the drainage grates at opposing ends of the adjoining channels, each of said end grates being of substantially the same length G2 being equal to [C.nC−C.(nC-1)]/2.

Preferably the drainage channel and grate assembly also comprises one or more joining sub-assemblies connected to adjoining of the plurality of drainage channels at respective of the channel junctions to provide additional rigidity to said junctions. More preferably each of the joining sub-assemblies includes a pair of joiner elements configured to clamp about the adjoining channels at the corresponding channel junction.

Preferably the drainage channel and grate assembly further comprises a channel support sub-assembly including:

a plurality of support members located underneath the plurality of adjoining drainage channels to support them;

a pair of pegs arranged to cooperate with each of the plurality of support members at respective of their opposing ends for anchoring of the support member to the ground.

More preferably said support sub-assembly also includes a pair of coupling arrangements mounted to respective of each of the pair of pegs, each of said coupling arrangements being configured where on anchoring of each of the support members to the ground via respective of the pair of pegs, said coupling arrangement either:
i) in a first install mode for the adjoining drainage channels, contacts an upper surface of the support member with the associated peg penetrating the ground along substantially the full length of the peg beneath the coupling arrangement, or
ii) in a second install mode for the adjoining drainage channels, couples to a fitting which contacts the upper surface of the support member, the coupling arrangement contacting a lower surface of the support member for suspension of the adjoining drainage channels above the ground with the peg penetrating the ground along part only of its full length.

Preferably the coupling arrangement includes a pair of longitudinally spaced flanges mounted to the associated peg. More preferably a lowermost of the pair of flanges is in the first install mode configured to contact the upper surface of the support member. Even more preferably an uppermost of the pair of flanges is in the second install mode configured to couple to the fitting, and the lowermost of the flanges is configured to contact the lower surface for suspension of the adjoining drainage channels.

Preferably each of the support members is elongate and includes a pair of openings at respective of its opposing ends, the pair of pegs designed for sliding receipt through respective of the pair of openings. More preferably the lowermost flange of the coupling arrangement is configured relative to the corresponding opening of the support member to prevent passage of the lowermost flange through the opening where either i) the lowermost flange in the first install mode contacts the upper surface of the support member in anchoring it to the ground via the associated peg with substantially full ground penetration, or ii) the lowermost flange in the second install mode contacts the lower surface of the support member in suspending the adjoining drainage channels above the ground. Even more preferably the uppermost flange of the coupling arrangement in the second install mode is configured relative to the corresponding opening of the support member for insertion of the uppermost flange through the opening for coupling to the fitting which contacts the upper surface of the support member to prevent retraction of the uppermost flange through the opening, the lowermost and uppermost flanges in combination with the fitting being effective in suspension of the support member above the ground.

Preferably the coupling arrangement is integral with the peg wherein the pair of spaced flanges are rigidly mounted to the peg. More preferably the uppermost of the flanges is located at an end of the associated peg at least in part forming a head adapted to cooperate with a tool designed for penetration of an opposing end portion of the peg into the ground. Even more preferably the opposing end portion of the peg is formed in a spearhead and the head of the coupling arrangement designed for hammering of the peg into the ground.

Preferably the fitting includes a base mounting designed to facilitate detachable mounting of the fitting to the uppermost of the flanges of the coupling arrangement. More preferably the fitting also includes a chair coupled to the base mounting for supporting a concrete reinforcing element above each of the support members. Even more preferably the chair includes a clip formed integral with the base mounting for releasable engagement and retention of the reinforcing element at a fixed height above the support members. Alternatively the chair is detachably mounted at one of a plurality of heights to an upright member connected to the base mounting, the chair thus being arranged to support the reinforcing element at a select height depending on said one of the plurality of heights at which the chair is mounted to the upright member.

Preferably each of the support members is adapted to releasably couple to the adjoining drainage channel for anchoring it to the support member. More preferably the support member is configured to interlock with one or more feet of the adjoining drainage channels.

### BRIEF DESCRIPTION OF DRAWINGS

In order to achieve a better understanding of the nature of the present invention a preferred embodiment of a drainage channel and grate assembly will now be described, by way of example only, with reference to the accompanying drawings in which:

FIGS. 1A and 1B are assembled and exploded views of a drainage channel and grate assembly of a first embodiment of the present invention;

FIGS. 2A and 2B are assembled and exploded views of a drainage channel and grate assembly of a second embodiment of the invention;

FIGS. 3A and 3B are assembled and exploded views of a drainage channel and grate assembly of a third embodiment of the invention;

FIGS. 4A and 4B are assembled and exploded views of a drainage channel and grate assembly of a fourth embodiment of the invention;

FIGS. 5A and 5B are assembled and exploded views of a drainage channel and grate assembly a fifth embodiment of the invention.

### DETAILED DESCRIPTION

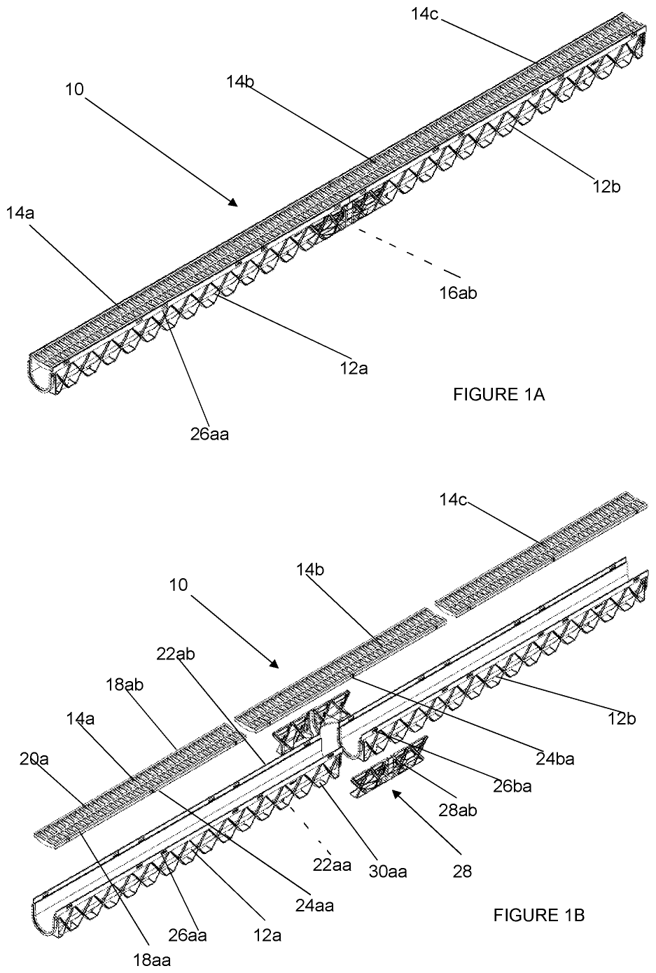

As seen in FIG. 1, there is a drainage channel and grate assembly 10 of a first embodiment of the invention and generally comprising a plurality of drainage channels 12a and 12b, and a plurality of drainage grates 14a to 14c. The drainage channels 12a/b adjoin one another at a channel junction 16ab in an end to end relationship. The drainage grates 14a to 14c are also arranged in an end to end relationship and in this embodiment are connected to either one or both of the drainage channels 12a/b. In this case, one of the plurality of drainage grates 14b bridges the channel junction 16ab to support the drainage channel and grate assembly 10 at said junction 16ab.

In this embodiment each of the drainage grates such as 14a includes an opposing pair of parallel rail members 18aa and 18ab interconnected by a series of parallel grate members such as 20a. The drainage channels such as 12a include a pair of opposing lands 22aa and 22ab upon which the opposing rail members 18aa and 18ab rest. In this embodiment each of the rail members such as 18aa includes one or more clips such as 24aa configured to releasably engage a corresponding window 26aa in the drainage channel 12a.

In this embodiment the drainage channel and grate assembly 10 also comprises a joining sub-assembly 28 connected to the adjoining drainage channels 12a/b at the channel junction 16ab. The joining sub-assembly 28 provides additional rigidity to the channel junction 16ab and in this example includes a pair of joiner elements such as 28ab. The pair of joiner elements 28ab are configured to clamp about the adjoining channels 12a/b at the channel junction 16ab. The joiner element such as 28ab of this example are of an exoskeletal form configured to connect to one another and nest within aligned hexagonal-shaped feet such as 30aa of the adjoining drainage channels such as 12a. In this embodiment it will be understood that the channel junction 16ab of the drainage channel and grate assembly 10 is a relatively rigid connection resulting from a combination of:
1. the bridging drainage grate 14b connected to the adjoining drainage channels 12a/b with which it interlocks via the mating arrangement of corresponding clips and windows such as 24ba and 26ba;
2. the joining sub-assembly 28 or the pair of joiner elements such as 28ab which clamp about the adjoining channels 12a/b at the channel junction 16ab.

In this first embodiment the two drainage channels 12a/b are of substantially the same length C. The drainage grate 14b bridging the channel junction 16ab is of substantially the same length as the remaining two drainage grates 14a and 14c at opposing ends of the adjoining channels 12a/b. This means the length G1 of the bridging grate 14b and the length G2 of the end grates 14a/c are each equal to 2C/3.

It is to be understood that two (2) of the drainage channel and grate assemblies such as 10 are suitable for a typical driveway or garage entrance having a width of around six metres. This means each of the drainage channel and grate assemblies 10 is typically 3 metres in length which is conveniently sized for shipping in a container or relatively compact for other transportation. In the context of the first embodiment, the two drainage channels 12a/b are thus 1.5 metres in length and the three drainage grates are each 1 metre in length. The drainage channels may be manufactured by moulding in a single or multiple cavity tool. The drainage grates 14a to 14c may be moulded in plastics or formed in metal using a press tool. It will be understood that the sizes and manufacturing techniques employed may vary from that described and remain within the scope of the present invention.

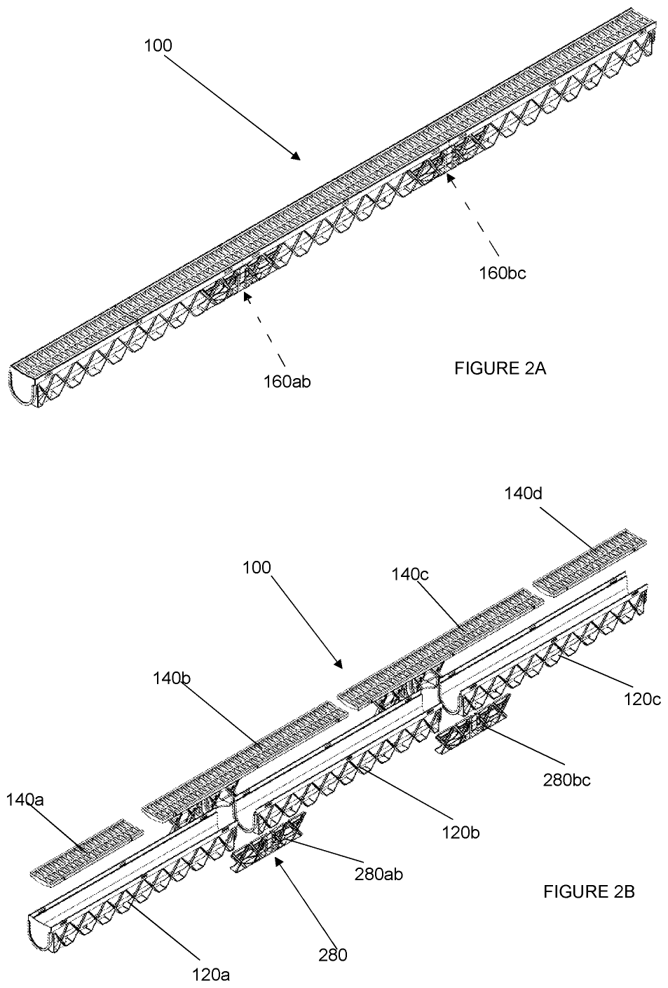

FIG. 2 illustrates a second embodiment of the invention representing a variation of the first embodiment described in the preceding paragraphs. For ease of reference and to avoid repetition, like components of the second embodiment have been designated with an additional “0” compared to the first embodiment. For example, the drainage channel and grate assembly of the second embodiment is designated 100.

The second embodiment is in essence substantially similar to the first embodiment with the following exceptions to the drainage channel and grate assembly 100:
1. there are three (3) drainage channels 120a to 120c joined in an end to end relationship at a pair of channel junctions 160ab and 160bc;
2. there are four (4) of the drainage grates 140a to 140d wherein two of these grates 140b and 140c bridge respective of the channel junctions 160ab and 160bc with the remaining two drainage grates 140a and 140d located at opposing ends of the adjoining channels 120a to 120c.

In this second embodiment the drainage channel and grate assembly 100 also comprises two (2) adjoining sub-assemblies such as 280 connected to adjoining of the three (3) drainage channels 120a to 120c at respective of the channel junctions 160ab and 160bc. In addition to the support provided by the bridging drainage grates 140b and 140c, the adjoining sub-assemblies such as 280 provide additional rigidity to respective of the junctions 160ab and 160bc. The adjoining sub-assemblies such 280 of the second embodiment are substantially identical to the first embodiment including a pair of joiner elements such as 280ab designed to clamp about the adjoining channels 120a/b at the corresponding channel junction 160ab.

In the second embodiment the three (3) drainage channels 120a to 120c are of substantially the same length C. The bridging drainage grates 140b and 140c are of substantially the same length G1 being equal to C. This means the remaining two grates 140a and 140d at opposing ends of the adjoining channels 120a to 120c are of substantially the same length G2 being equal to C/2. In a variation on the second embodiment (not illustrated) the four (4) drainage grates are replaced with two (2) drainage grates bridging the channel junctions 160ab and 160bc. In this case each of the bridging grates is substantially of the same length G being equal to 3C/2.

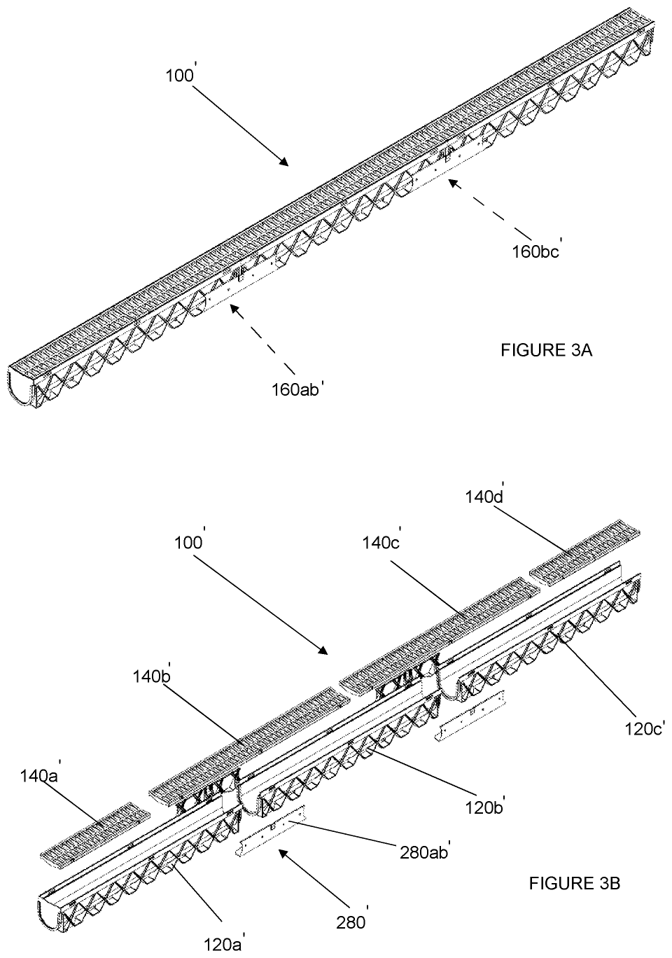

FIG. 3 illustrates a third embodiment of a drainage channel and grate assembly 100′ which is substantially identical to the second embodiment with the exception of the adjoining sub-assemblies such as 280′. In this case the adjoining sub-assemblies 280′ each include a pair of joiner elements such as 280ab′ each being of a substantially solid construction. The solid joiner elements such as 280ab′ may be press-fit and/or screwed to the adjoining drainage channels 120a and 120b, typically independent of one another.

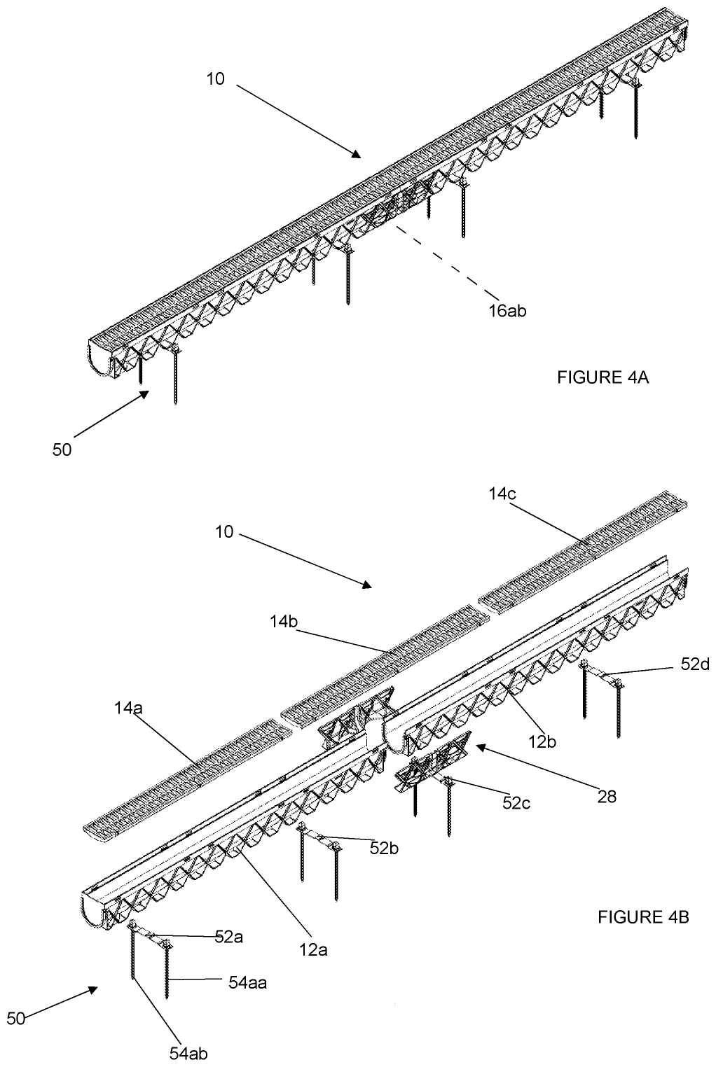

FIG. 4 illustrates a fourth embodiment of the drainage channel and grate assembly 10 which is substantially identical to the first embodiment and further comprises a channel support sub-assembly designated generally at 50. The channel support sub-assembly 50 of this example includes:
1. a plurality of support members 52a to 52d located underneath the plurality of adjoining drainage channels 12a and 12b to support them;
2. a pair of pegs such as 54aa and 54ab dedicated to each of the support members such as 52a for anchoring of the support member 52a to the ground (not shown).

The support sub-assembly 50 is described and illustrated in more detail in the applicant's co-pending and published International patent application no. WO2020/041823. The disclosures of this International patent application are to be considered included herein by way of this reference.

In a first install mode, the drainage channel and grate assembly 10 is installed in a soft scape application in which case the plurality of adjoining drainage channels 12a/b are generally surrounded in soil or other landscaping material. In a second install mode, the drainage channels 12a/b are suspended above ground via the channel support sub-assembly 50 in a trench in preparation for a concrete pour which will surround the drainage channels 12a/b.

In the second install mode for this fourth embodiment, the in-situ drainage grates 14a to 14c and in particular the bridging grate 14b improves the rigidity of the adjoining drainage channels 12a/b. That is, the bridging grate 14b provides additional strength and resistance to rotation when concrete is poured around the adjoining drainage channels 12a/b which are suspended in the second install mode. In this case, the joining sub-assembly 28 provides additional rigidity to the junction 16ab wherein the adjoining drainage channels 12a/b are particularly strong and thus resistant to torsional forces exerted by a concrete pour.

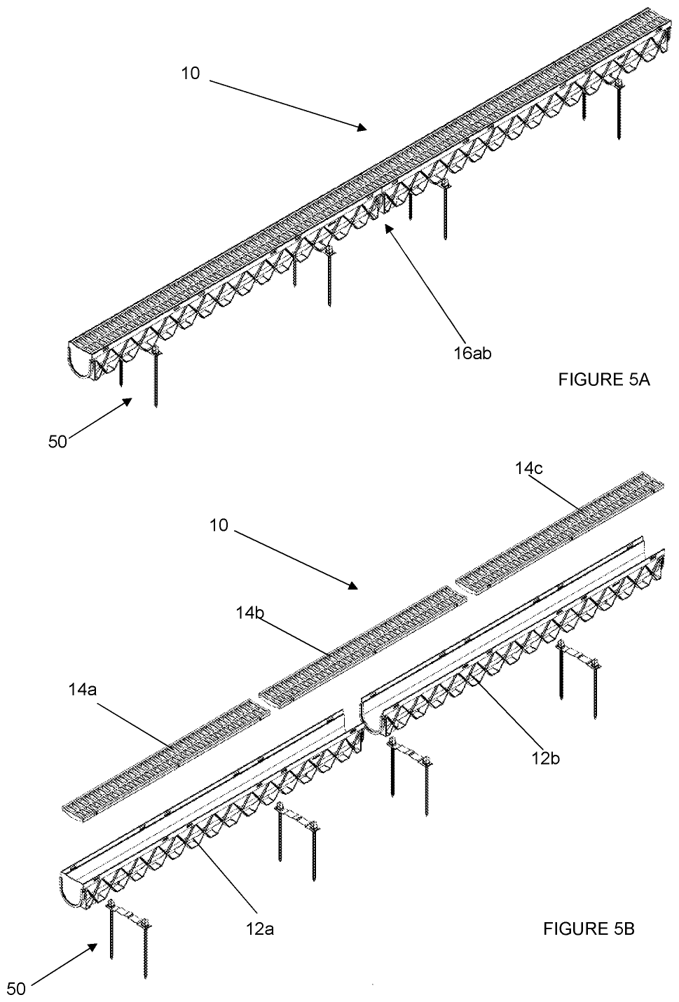

FIG. 5 illustrates a fifth embodiment which is substantially identical to the fourth embodiment but without the joining sub-assembly 28. The adjoining drainage channels such as 12a/b of this fifth and all preceding embodiments include a male/female connection as an integral part of the adjoining drainage channels 12a/b at the channel junction such as 16ab. It is expected that the drainage channel and grate assembly 10 of this embodiment in the absence of the joining sub-assembly 28 nonetheless exhibit adequate rigidity for transportation and installation. It will thus be understood that any one of the preceding embodiments may equally exclude the joining sub-assembly 28 and remain within the scope of the present invention.

Now that preferred embodiments of the drainage channel and grate assembly of the invention have been described it will be apparent to those skilled in the art that they have at least the following advantages:
1. the inclusion of drainage grates bridging channel junctions provides additional support or rigidity for the drainage channel and grate assembly which is less susceptible to separation or unwanted twisting;
2. the relatively robust drainage channel and grate assembly lends itself to transportation at various stages in the supply chain;
3. the drainage channel and grate assembly with the grate in-situ provides the additional strength required in the second install mode under the influence of a concrete pour;
4. the assembly with potentially less components and in particular adjoining drainage channels reduces the time and associated cost of labour to assemble.

Those skilled in the art will appreciate that the invention as described herein is susceptible to variations and modifications other than those specifically described. For example, the drainage channel and grate assembly extends to drainage grates with either regular or irregular lengths in combination with drainage channels of variable overall lengths. Although it is preferred that the drainage channels are of equal lengths, the invention extends to assemblies where the drainage channels may vary in length. In effect the invention is to be understood to extend to practically any geometry provided each of the channel junctions is supported by a bridging drainage grate.

All such variations and modifications are to be considered within the scope of the present invention the nature of which is to be determined from the foregoing description.

1. A drainage channel and grate assembly comprising:
a plurality of drainage channels adjoining one another at one or more channel junctions in an end to end relationship;
a plurality of drainage grates connected to the drainage channels, at least one of said grates bridging respective of the channel junctions to support the drainage channel and grate assembly at said channel junction.

2. A drainage channel and grate assembly as claimed in claim 1 wherein there are two (2) of the plurality of drainage channels each being of substantially the same length C, one (1) of the plurality of drainage grates bridging the channel junction, said bridging grate being of length G1 being equal to 2C/3.

3. A drainage channel and grate assembly as claimed in claim 2 comprising drainage grates at opposing ends of the adjoining channels, each of said end grates being of substantially the same length G2 being equal to G1.

4. A drainage channel and grate assembly as claimed in claim 1 wherein there are three (3) of the plurality of drainage channels each being of substantially the same length C, two (2) of the plurality of drainage grates bridging the channel junctions each of said bridging grates being of substantially the same length G1 being equal to C.

5. A drainage channel and grate assembly as claimed in claim 4 comprising drainage grates at opposing ends of the adjoining channels, each of said end grates being of substantially the same length G2 being equal to C/2.

6. A drainage channel and grate assembly as claimed in claim 4 wherein there are two (2) of the plurality of drainage grates bridging the channel junctions each of said bridging grates being of substantially the same length G being equal to 3C/2.

7. A drainage channel and grate assembly as claimed in claim 1 wherein there are nC of the plurality of drainage channels each being of substantially the same length C, where nC is equal to or great than four (4).

8. A drainage channel and grate assembly as claimed in claim 7 wherein there are nG of the plurality of drainage grates bridging the channel junctions each of said bridging grates being substantially the same length G1 being equal to C, where nG is equal to nC−1.

9. A drainage channel and grate assembly as claimed in claim 8 comprising two (2) of the drainage grates at opposing ends of the adjoining channels, each of said end grates being of substantially the same length G2 being equal to [C.nC−C.(nC−1)]/2.

10. A drainage channel and grate assembly as claimed in claim 1 also comprising one or more joining sub-assemblies connected to adjoining of the plurality of drainage channels at respective of the channel junctions to provide additional rigidity to said junctions.

11. A drainage channel and grate assembly as claimed in claim 10 wherein each of the joining sub-assemblies includes a pair of joiner elements configured to clamp about the adjoining channels at the corresponding channel junction.

12. A drainage channel and grate assembly as claimed in claim 1 further comprising a channel support sub-assembly including:
a plurality of support members located underneath the plurality of adjoining drainage channels to support them;
a pair of pegs arranged to cooperate with each of the plurality of support members at respective of their opposing ends for anchoring of the support member to the ground.

13. A drainage channel and grate assembly as claimed in claim 4 wherein said support sub-assembly also includes a pair of coupling arrangements mounted to respective of each of the pair of pegs, each of said coupling arrangements being configured where on anchoring of each of the support members to the ground via respective of the pair of pegs, said coupling arrangement either:
i) in a first install mode for the adjoining drainage channels, contacts an upper surface of the support member with the associated peg penetrating the ground along substantially the full length of the peg beneath the coupling arrangement, or
ii) in a second install mode for the adjoining drainage channels, couples to a fitting which contacts the upper surface of the support member, the coupling arrangement contacting a lower surface of the support member for suspension of the adjoining drainage channels above the ground with the peg penetrating the ground along part only of its full length.

14. A drainage channel and grate assembly as claimed in claim 13 wherein the coupling arrangement includes a pair of longitudinally spaced flanges mounted to the associated peg, a lowermost of the pair of flanges in the first install mode configured to contact the upper surface of the support member, and an uppermost of the pair of flanges in the second install mode configured to couple to the fitting, and the lowermost of the flanges is configured to contact the lower surface for suspension of the adjoining drainage channels.

15. A drainage channel and grate assembly as claimed in claim 14 wherein each of the support members is elongate and includes a pair of openings at respective of its opposing ends, the pair of pegs designed for sliding receipt through respective of the pair of openings.

16. A drainage channel and grate assembly as claimed in claim 15 wherein the lowermost flange of the coupling arrangement is configured relative to the corresponding opening of the support member to prevent passage of the lowermost flange through the opening where either i) the lowermost flange in the first install mode contacts the upper surface of the support member in anchoring it to the ground via the associated peg with substantially full ground penetration, or ii) the lowermost flange in the second install mode contacts the lower surface of the support member in suspending the adjoining drainage channels above the ground.

17. A drainage channel and grate assembly as claimed in claim 15 wherein the uppermost flange of the coupling arrangement in the second install mode is configured relative to the corresponding opening of the support member for insertion of the uppermost flange through the opening for coupling to the fitting which contacts the upper surface of the support member to prevent retraction of the uppermost flange through the opening, the lowermost and uppermost flanges in combination with the fitting being effective in suspension of the support member above the ground.

18. A drainage channel and grate assembly as claimed in claim 14 wherein the coupling arrangement is integral with the peg wherein the pair of spaced flanges are rigidly mounted to the peg, the uppermost of the flanges located at an end of the associated peg at least in part forming a head adapted to cooperate with a tool designed for penetration of an opposing end portion of the peg into the ground.

19. A drainage channel and grate assembly as claimed in claim 14 wherein the fitting includes a base mounting designed to facilitate detachable mounting of the fitting to the uppermost of the flanges of the coupling arrangement, the fitting also including a chair coupled to the base mounting for supporting a concrete reinforcing element above each of the support members.

20. A drainage channel and grate assembly as claimed in claim 19 wherein the chair includes a clip formed integral with the base mounting for releasable engagement and retention of the reinforcing element at a fixed height above the support members.
